(19) United States
(12) Patent Application Publication
(10) Pub. No.: US 2026/0051577 A1
(43) Pub. Date: Feb. 19, 2026

(54) STRUCTURALLY STRENGTHENED BATTERY ENCLOSURE

(71) Applicant: GM GLOBAL TECHNOLOGY OPERATIONS LLC, Detroit, MI (US)

(72) Inventors: Liang Xi, Northville, MI (US); SriLakshmi Katar, Troy, MI (US); Arturo Sanchez Perez, Rochester Hills, MI (US)

(73) Assignee: GM GLOBAL TECHNOLOGY OPERATIONS LLC, Detroit, MI (US)

(21) Appl. No.: 18/801,967

(22) Filed: Aug. 13, 2024

(51) Int. Cl. H01M 50/133; H01M 10/613; H01M 10/6554; H01M 10/658

(52) U.S. Cl. CPC H01M 50/133; H01M 10/613; H01M 10/6554; H01M 10/658; H01M 2220/20

(57) ABSTRACT

Battery enclosures, vehicle with battery enclosures, and methods for improving thermal performance of battery enclosures are provided. A method for improving thermal performance of a battery enclosure includes forming the battery enclosure with a bottom wall and a side wall, wherein the side wall includes a bottom section, a middle section, and a top section; reducing a thickness of the middle section and top section to form a bottom step between the bottom section and the middle section; forming a top step from the top section; and locating internal battery components within the battery enclosure. The top step has a first thickness, the bottom step has a second thickness, and the middle section has a third thickness; the first thickness is greater than the third thickness; and the second thickness is greater than the third thickness.

### INTRODUCTION

The disclosure relates to rechargeable energy storage systems (“RESS”) and more particularly relates to battery enclosures within rechargeable energy storage systems.

Rechargeable energy storage systems, including lithium-ion and related batteries, are increasingly being used in a variety of fields as a way to more efficiently generate, store, and distribute electrical power. In automotive applications, rechargeable energy storage systems are being used as a way to supplement, in the case of hybrid electric vehicles (HEVs), or supplant, in the case of purely electric vehicles (EVs), i.e., battery electric vehicles (BEVs), conventional internal combustion engines. The ability to passively store energy from stationary and portable sources, as well as from recaptured kinetic energy provided by the vehicle and its components, makes batteries ideal to serve as part of a propulsion system for cars, trucks, buses, motorcycles and related vehicular platforms. In the present context, a cell is a single electrochemical unit, whereas a battery is made up of one or more cells joined in series, parallel or both, depending on desired output voltage and capacity.

Temperature is one of the most significant factors impacting both the performance and life of a battery. Environmental temperatures (such as those encountered during protracted periods of inactivity in cold or hot environments, or due to extended periods of operation and concomitant heat generation on hot days) or abuse conditions (such as the rapid charge/discharge, or internal/external shorts caused by the physical deformation, penetration, or manufacturing defects of the cells) can negatively impact the ability of the battery to operate correctly, and in severe cases can destroy the battery entirely. Side effects of prolonged exposure to high temperature may include premature aging and accelerated capacity fade, both of which are undesirable.

Excess heat can be provided by an internal short circuit in a battery cell. An onset temperature is that temperature at which an exothermic reaction occurs. The heat required to maintain such an exothermic reaction is known as the heat of reaction, while a heat source that exceeds the onset temperature and maintains the heat of reaction is a thermal event. Such thermal events, if left uncontrolled, could potentially lead to a more accelerated heat generation condition, referred to herein as thermal runaway, a condition where (once initiated) the cooling mechanism is incapable of returning one or more of the battery components to a safe operating temperature. In the present context, a thermal runaway is a function of the self-heating rate of the exothermic reaction and the temperature, and the time of the reaction is a function of the rate of degradation and the mass of active components taking part in such reaction. Of particular concern is the possibility for excess heating of, and concomitant damage to, a battery cell, group, pack or related member being used as a source of propulsive power.

Accordingly, it is desirable to provide battery enclosures and methods for improving thermal performance of battery enclosures. Further, it is desirable to structurally strengthen battery enclosures. Other desirable features and characteristics of the present disclosure will become apparent from the subsequent detailed description and the appended claims, taken in conjunction with the accompanying drawings and the foregoing introduction.

### SUMMARY

In an embodiment, a method for improving thermal performance of a battery enclosure includes forming the battery enclosure with a bottom wall and a side wall, wherein the side wall includes a bottom section, a middle section, and a top section; reducing a thickness of the middle section and top section to form a bottom step between the bottom section and the middle section; forming a top step from the top section; and locating internal battery components within the battery enclosure. In the method, the top step has a first thickness, the bottom step has a second thickness, and the middle section has a third thickness; the first thickness is greater than the third thickness; and the second thickness is greater than the third thickness.

In certain embodiments of the method, forming the top step includes folding the top section to create a fold and inserting a wedge into the fold.

In certain embodiments of the method, forming the top step further includes welding together the fold and the wedge.

In certain embodiments of the method, forming the top step includes placing a sleeve around the top section and welding the sleeve to the top section to form the top step.

In certain embodiments of the method, the first thickness is at least 1.5 times greater than the third thickness.

In certain embodiments of the method, the second thickness is at least 1.5 times greater than the third thickness.

In certain embodiments of the method, the top step surrounds the top section of the battery enclosure, and the bottom step surrounds the bottom section of the battery enclosure.

In certain embodiments of the method, improving thermal performance includes placing a cold plate below the bottom section of the battery enclosure.

In certain embodiments of the method, improving thermal performance further includes transferring heat from the bottom section to the cold plate.

In certain embodiments of the method, the battery enclosure is a first battery enclosure, and the method further includes placing a second battery enclosure adjacent to the first battery enclosure, wherein a gap is defined between the first battery enclosure and the second battery enclosure; and placing a barrier within the gap between the first battery enclosure and the second battery enclosure.

In certain embodiments, the method further includes configuring the middle section of the first battery enclosure to expand freely into the gap.

In certain embodiments of the method, is comprised of a thermal barrier.

In another embodiment, a battery enclosure is provided and includes a bottom wall; a side wall including a bottom section, a middle section, and a top section; a bottom step; and a top step. In the battery enclosure, the top step has a first thickness, the bottom step has a second thickness and the middle section has a third thickness; the first thickness is greater than the third thickness and the second thickness is greater than the third thickness.

In certain embodiments of the battery enclosure, the top step and bottom step are configured to reduce rupture risk of the battery enclosure.

In certain embodiments of the battery enclosure, the bottom step is configured to transfer heat to a cold plate.

In certain embodiments of the battery enclosure, the bottom step completely surrounds the bottom section of the battery enclosure.

In certain embodiments of the battery enclosure, the top step completely surrounds the top section of the battery enclosure.

In certain embodiments of the battery enclosure, the first thickness is at least 1.5 times greater than the third thickness.

In certain embodiments of the battery enclosure, the second thickness is at least 1.5 times greater than the third thickness.

In another embodiment, a vehicle is provided and includes an electric motor configured to provide motive torque; and a battery system operatively connected to the electric motor and operable to provide electrical power to the electric motor, wherein the battery system includes a battery enclosure surrounding an internal space and including a bottom wall and a side wall, wherein the side wall includes a bottom section, a middle section, and a top section; a bottom step is formed at a bottom interface between the bottom section and the middle section; a top step is formed at a top interface between the top section and the middle section; the top section is at least 1.5 times thicker than the middle section; the bottom section is at least 1.5 times thicker than the middle section; the bottom step is configured to transfer heat; the bottom step and top step are configured to structurally strengthen the battery enclosure; the middle section is configured to allow swelling of internal battery components by expanding to increase a volume of the internal space.

### DESCRIPTION OF THE DRAWINGS

The present disclosure will hereinafter be described in conjunction with the following drawing figures, wherein like numerals denote like elements, and wherein:

FIG. 1 is a schematic perspective view of an electric vehicle with a cut-away section to reveal a battery assembly including battery cells in accordance with exemplary embodiments.

FIG. 2 is a perspective view of a battery cell of the battery assembly of FIG. 1, in accordance with exemplary embodiments.

FIG. 3 is a cross-sectional schematic view of a portion of the battery cell of FIG. 2, in accordance with exemplary embodiments.

FIG. 4 is a flow chart illustrating a method for improving thermal performance of a battery enclosure in accordance with exemplary embodiments.

FIGS. 5-11 are cross-sectional schematic views, similar to FIG. 3, illustrating stages of fabrication of the battery enclosure and battery according to the method of FIG. 4, in accordance with exemplary embodiments.

FIG. 12 is a cross-sectional schematic view of a portion of the battery cell of FIG. 2, in accordance with exemplary embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

Embodiments of the present disclosure may be described herein in terms of functional and/or logical block components and various processing steps. Connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments herein may provide for improved battery cell materials and/or improved battery cell fabrication methods. More specifically, embodiments herein provide a high strength can or enclosure design for a large energy battery cell to improve cell safety during cell thermal runaway. For example, embodiments herein provide a stepped enclosure design that provides for a lower cell mass/higher cell energy ratio. Further, embodiments herein provide a stepped enclosure design that provides for increased structural strength at corners of the battery enclosure.

A large energy cell, i.e., greater than 1 kWh, holds promise for significantly reducing battery pack costs. The cost of cell mechanical components, such as the cap plate, remains similar on a per-piece basis, but the cost per kWh decreases with higher cell energy, resulting in lower overall cell costs. Additionally, larger cell energy allows for fewer cells in a pack, reducing the number of components, overall pack cost, and mass.

However, large energy cells pose higher risks of cell rupture during thermal runaway due to the increased energy and gas release. Embodiments herein address this higher risk by providing a stepped case or enclosure design that strengthens the weak points at enclosure corners, effectively reducing the risks of cell rupture without significantly increasing cell mass or reducing cell energy. The stepped case design may also reduce internal cell swelling forces by setting an initial cell-to-cell space or void providing for enclosure expansion at selected sections. Furthermore, embodiments herein may improve thermal performance by increasing the heat conduction or transfer area.

In certain embodiments, the enclosure design includes varied side wall thicknesses with locally thicker side walls at and near enclosure corners to strengthen the enclosure without dramatically increasing the cell mass or decreasing cell energy.

In certain embodiments, the enclosure design introduces a gap between battery cells in the battery module, which allows each cell to expand and reduces the internal cell swelling force.

In certain embodiments, the enclosure design provides a larger thermal conduction area that facilitates heat conduction to a cold plate and improves thermal performance of the enclosure.

In certain embodiments, the enclosure design can be introduced during prismatic case manufacturing processing and may include folding and welding or extrusion or deep drawing. For deep drawing, a thicker can wall section near the bottom surface can be established during an ironing phase of the can deep drawing process. Further a top section may be formed by folding and then welding to increase the wall thickness.

In certain embodiments, methods for forming the enclosure include welded or adhering a metal plate or sleeve onto the box-like enclosure. In such embodiments, the metal plate or sleeve could be a different material from the can base material, such as copper.

Embodiments herein are applicable to various cell chemistries and are applicable to both electrode stack and wound jelly roll designs.

Certain embodiments provide a cell array including a thermal barrier material between cells and gaps between the thermal barrier material and portions of the cells. This design allows cells to expand without constraint to reduce the internal cell swelling force at end of life. Alternatively, a soft foam can be used to fill the gap without constraining cell expansion.

In certain embodiments, a stepped case design is used for a large energy cell to improve thermal performance. The stepped case is locally thicker near the cooling surfaces to facilitate heat conduction. Cooling locations may include top walls, side walls, and bottom walls.

Certain embodiments provide for improved cell thermal performance with lower cell maximum temperature during charging and discharging. Certain embodiments provide for improved cell life because of lower cell maximum operation temperatures. Certain embodiments provide for improved abuse performance.

Embodiments of the present disclosure offer advantages over the existing art, though it is understood that other embodiments may offer different advantages, not all advantages are necessarily discussed herein, and no particular advantage is required for all embodiments.

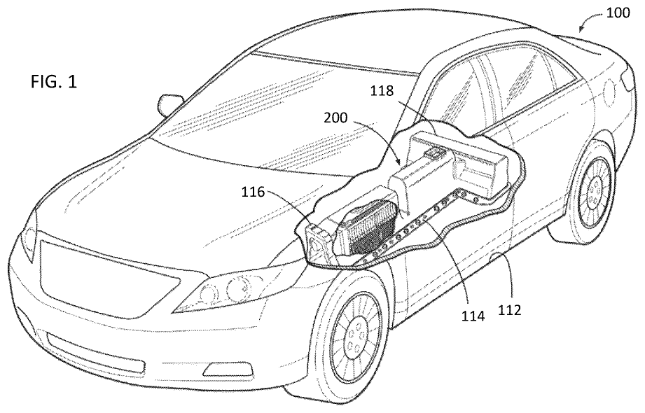

Referring to the drawings, wherein like reference numbers correspond to like or similar components wherever possible throughout the several figures, an electric vehicle 100 having a rechargeable energy storage system (“RESS”) 200 including a plurality of battery cells in a battery assembly, is shown in FIG. 1. The term “battery” used alone herein may refer to a battery module, battery cell or cell stack. The term “battery pack” used alone may refer to a battery and the battery enclosure system the battery is housed within.

FIG. 1 illustrates the electric vehicle 100 as an automobile, such as any one of a number of different types of automobiles, such as, for example, a sedan, a wagon, a truck, sport utility vehicle (SUV), or the like. In certain implementations, the vehicle 100 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the RESS 200 may instead be part of and/or coupled to any number of other types of platforms and/or other systems, moving or non-moving, such as a building, infrastructure, secondary use, home power, non-automotive, and/or other platforms and/or other systems.

The illustrated electric vehicle 100 includes a vehicle chassis 112. The RESS 200 includes a battery module 118 and is provided with a battery tray 114 for supporting the battery module 118. The battery tray 114 may attach to the vehicle chassis 112 to secure the battery module 118 in the RESS 200 to the electric vehicle 100. The electric vehicle 100 may also include a battery disconnect unit 116, which is connected to the battery module 118 of the RESS 200. In exemplary embodiments, battery module 118 is an assembly of battery cells.

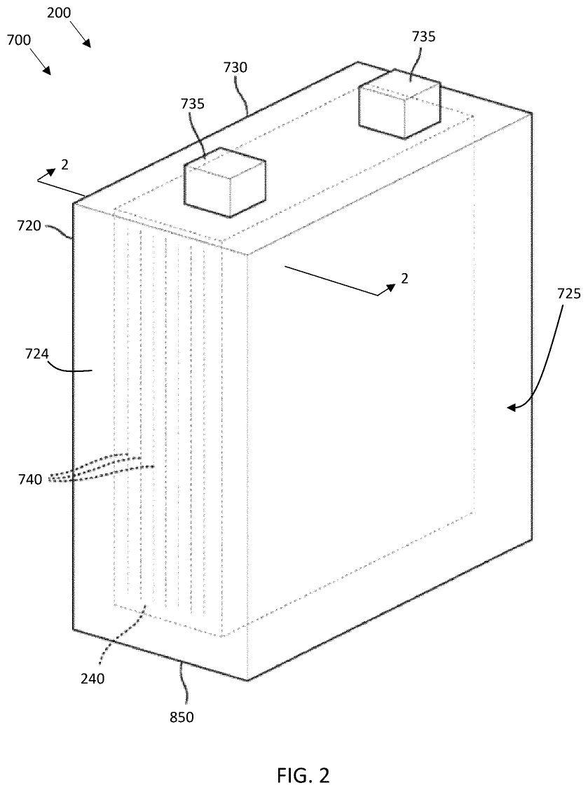

FIG. 2 is a schematic perspective view of a battery cell 700 of the battery module 118 of FIG. 1. Specifically, FIG. 2 illustrates a prismatic battery cell 700.

The prismatic battery cell 700 is illustrated as including an outer case or enclosure 720 that surrounds and defines an internal space 725 within the enclosure 720. An exemplary outer enclosure 720 may be conductive. For example, the outer enclosure 720 may be metallic. In certain embodiments, the enclosure 720 is aluminum. The illustrated outer enclosure 720 is a rectangular polyhedron formed from four side walls 724, though the enclosure 720 may be of any suitable shape. The enclosure 720 includes a bottom wall 850.

The outer enclosure 720 may be formed with an open top end, which is covered or closed by a cap 860. In certain embodiments, the cap 860 may be part of the enclosure 720. In certain embodiments, the cap 860 is conductive. For example, the cap 860 may be metallic, such as aluminum or aluminum alloy.

As shown, the battery cell 700 may include tabs or terminals 735, which may be in electrical connection with the battery cell components within the outer enclosure 720. In certain embodiments, each terminal 735 is insulated from the cap 860.

In certain embodiments, the battery cell 700 includes an electrode assembly. As shown, the electrode assembly 740 is illustrated with dashed lines, indicating the electrode assembly 740 as a component of the prismatic battery cell 700 that is internal to the hard outer enclosure 720, i.e., located within the internal space 725.

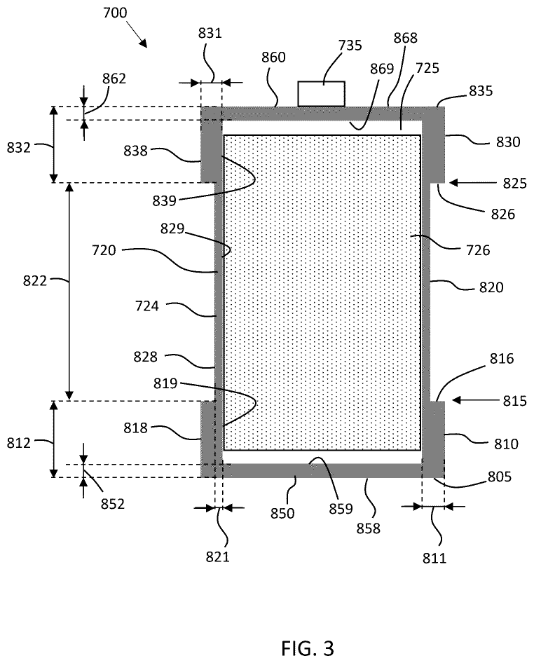

FIG. 3 is a cross-sectional schematic of the battery cell 700 of FIG. 2. In FIG. 3, internal components of the battery cell 700 are generally indicated by reference number 726.

As shown in FIG. 3, each of the side walls 724 of the outer enclosure 720 is formed with a bottom section 810, a middle section 820, and a top section 830. The bottom section 810 joins the middle section 820 at an interface 815 or step 815. The middle section 820 joins the top section 830 at an interface 825 or step 825.

As shown in FIG. 3, the bottom section 810 of each side wall 724 has an inner surface 819 defining the internal space 725. Further, the bottom section 810 of each side wall 724 has an outer surface 818. As shown, the bottom section 810 of each side wall 724 has a thickness 811 extending between the inner surface 819 and the outer surface 818.

As further shown, the bottom section 810 extends from interface 815 to a bottom surface 805. The bottom section 810 terminates at the bottom surface 805 and at the interface 815. The bottom section 810 has a vertical height 812.

As shown in FIG. 3, the top section 830 of each side wall 724 has an inner surface 839 defining the internal space 725. Further, the top section 830 of each side wall 724 has an outer surface 838. As shown, the top section 830 of each side wall 724 has a thickness 831 extending between the inner surface 839 and the outer surface 838.

As further shown, the top section 830 extends from interface 825 to a top surface 835. The top section 830 terminates at the top surface 835 and at the interface 825. The top section 830 has a vertical height 832.

In FIG. 3, the middle section 820 of each side wall 724 has an inner surface 829 defining the internal space 725. Further, the middle section 820 of each side wall 724 has an outer surface 828. As shown, the middle section 820 of each side wall 724 has a thickness 821 extending between the inner surface 829 and the outer surface 828.

As further shown, the middle section 820 extends from interface 815 to interface 825. The middle section 820 terminates at the interface 815 and at the interface 825. The middle section 820 has a vertical height 822.

In certain embodiments, the bottom thickness 811 is greater than the middle thickness 821. For example, bottom thickness 811 may be at least 1.1 times the middle thickness 821, such as at least 1.2 times the middle thickness 821, at least 1.3 times the middle thickness 821, at least 1.4 times the middle thickness 821, at least 1.5 times the middle thickness 821, at least 1.6 times the middle thickness 821, at least 1.7 times the middle thickness 821, at least 1.8 times the middle thickness 821, at least 1.9 times the middle thickness 821, at least 2 times the middle thickness 821, at least 2.25 times the middle thickness 821, or at least 2.5 times the middle thickness 821.

In certain embodiments, bottom thickness 811 may be at most 1.2 times the middle thickness 821, such as at most 1.3 times the middle thickness 821, at most 1.4 times the middle thickness 821, at most 1.5 times the middle thickness 821, at most 1.6 times the middle thickness 821, at most 1.7 times the middle thickness 821, at most 1.8 times the middle thickness 821, at most 1.9 times the middle thickness 821, at most 2 times the middle thickness 821, at most 2.25 times the middle thickness 821, at most 2.5 times the middle thickness 821, or at most 3 times the middle thickness 821.

In certain embodiments, the top thickness 831 is greater than the middle thickness. 821. For example, top thickness 831 may be at least 1.1 times the middle thickness 821, such as at least 1.2 times the middle thickness 821, at least 1.3 times the middle thickness 821, at least 1.4 times the middle thickness 821, at least 1.5 times the middle thickness 821, at least 1.6 times the middle thickness 821, at least 1.7 times the middle thickness 821, at least 1.8 times the middle thickness 821, at least 1.9 times the middle thickness 821, at least 2 times the middle thickness 821, at least 2.25 times the middle thickness 821, or at least 2.5 times the middle thickness 821.

In certain embodiments, top thickness 831 may be at most 1.2 times the middle thickness 821, such as at most 1.3 times the middle thickness 821, at most 1.4 times the middle thickness 821, at most 1.5 times the middle thickness 821, at most 1.6 times the middle thickness 821, at most 1.7 times the middle thickness 821, at most 1.8 times the middle thickness 821, at most 1.9 times the middle thickness 821, at most 2 times the middle thickness 821, at most 2.25 times the middle thickness 821, at most 2.5 times the middle thickness 821, or at most 3 times the middle thickness 821.

In certain embodiments, bottom thickness 811 and top thickness 831 are equal. In certain embodiments, bottom thickness 811 is at least 0.75 times the top thickness 831, such as at least 0.8 times the top thickness 831, at least 0.85 times the top thickness 831, at least 0.9 times the top thickness 831, at least 0.95 times the top thickness 831, at least 1.05 times the top thickness 831, at least 1.1 times the top thickness 831, at least 1.15 times the top thickness 831, at least 1.2 times the top thickness 831, or at least 1.25 times the top thickness 831. In certain embodiments, bottom thickness 811 is at most 0.75 times the top thickness 831, such as at most 0.8 times the top thickness 831, at most 0.85 times the top thickness 831, at most 0.9 times the top thickness 831, at most 0.95 times the top thickness 831, at most 1.05 times the top thickness 831, at most 1.1 times the top thickness 831, at most 1.15 times the top thickness 831, at most 1.2 times the top thickness 831, or at most 1.25 times the top thickness 831.

In certain embodiments, the bottom height 812 is less than the middle height 822. For example, bottom height 812 may be at least 0.1 times the middle height 822, such as at least 0.2 times the middle height 822, at least 0.3 times the middle height 822, at least 0.4 times the middle height 822, at least 0.5 times the middle height 822, at least 0.6 times the middle height 822, at least 0.7 times the middle height 822, at least 0.8 times the middle height 822, or at least 0.9 times the middle height 822.

In certain embodiments, bottom height 812 may be at most 0.1 times the middle height 822, such as at most 0.2 times the middle height 822, at most 0.3 times the middle height 822, at most 0.4 times the middle height 822, at most 0.5 times the middle height 822, at most 0.6 times the middle height 822, at most 0.7 times the middle height 822, at most 0.8 times the middle height 822, or at most 0.9 times the middle height 822.

In certain embodiments, the top height 832 is less than the middle height 822. For example, top height 832 may be at least 0.1 times the middle height 822, such as at least 0.2 times the middle height 822, at least 0.3 times the middle height 822, at least 0.4 times the middle height 822, at least 0.5 times the middle height 822, at least 0.6 times the middle height 822, at least 0.7 times the middle height 822, at least 0.8 times the middle height 822, or at least 0.9 times the middle height 822.

In certain embodiments, top height 832 may be at most 0.1 times the middle height 822, such as at most 0.2 times the middle height 822, at most 0.3 times the middle height 822, at most 0.4 times the middle height 822, at most 0.5 times the middle height 822, at most 0.6 times the middle height 822, at most 0.7 times the middle height 822, at most 0.8 times the middle height 822, or at most 0.9 times the middle height 822.

In certain embodiments, bottom height 812 and top height 832 are equal. In certain embodiments, bottom height 812 is at least 0.75 times the top height 832, such as at least 0.8 times the top height 832, at least 0.85 times the top height 832, at least 0.9 times the top height 832, at least 0.95 times the top height 832, at least 1.05 times the top height 832, at least 1.1 times the top height 832, at least 1.15 times the top height 832, at least 1.2 times the top height 832, or at least 1.25 times the top height 832. In certain embodiments, bottom height 812 is at most 0.75 times the top height 832, such as at most 0.8 times the top height 832, at most 0.85 times the top height 832, at most 0.9 times the top height 832, at most 0.95 times the top height 832, at most 1.05 times the top height 832, at most 1.1 times the top height 832, at most 1.15 times the top height 832, at most 1.2 times the top height 832, or at most 1.25 times the top height 832.

As shown in FIG. 3, a bottom shoulder or bottom step surface 816 is located at the interface 815 and interconnects the bottom outer surface 818 and middle outer surface 828. The bottom step surface 816 may be substantially horizontal and/or substantially parallel to the bottom surface 805. The bottom step surface 816 may have a horizontal length equal to the difference of bottom thickness 811 and middle thickness 821.

As shown in FIG. 3, a top shoulder or top step surface 826 is located at the interface 825 and interconnects the top outer surface 838 and middle outer surface 828. The top step surface 826 may be substantially horizontal and/or substantially parallel to the top surface 835. The top step surface 826 may have a horizontal length equal to the difference of top thickness 831 and middle thickness 821.

In FIG. 3, the bottom wall 850 has an inner surface 859 defining the internal space 725. Further, the bottom wall 850 has an outer surface 858. As shown, the bottom wall 850 has a vertical thickness 852 extending between the inner surface 859 and the outer surface 858.

In FIG. 3, the top cap 860 has an inner surface 869 defining the internal space 725. Further, the top cap 860 has an outer surface 868. As shown, the top cap 860 has a vertical thickness 862 extending between the inner surface 869 and the outer surface 868.

In certain embodiments, vertical thickness 852 and vertical thickness 862 are equal. In certain embodiments, bottom vertical thickness 852 is at least 0.75 times the top vertical thickness 862, such as at least 0.8 times the top vertical thickness 862, at least 0.85 times the top vertical thickness 862, at least 0.9 times the top vertical thickness 862, at least 0.95 times the top vertical thickness 862, at least 1.05 times the top vertical thickness 862, at least 1.1 times the top vertical thickness 862, at least 1.15 times the top vertical thickness 862, at least 1.2 times the top vertical thickness 862, or at least 1.25 times the top vertical thickness 862. In certain embodiments, bottom vertical thickness 852 is at most 0.75 times the top vertical thickness 862, such as at most 0.8 times the top vertical thickness 862, at most 0.85 times the top vertical thickness 862, at most 0.9 times the top vertical thickness 862, at most 0.95 times the top vertical thickness 862, at most 1.05 times the top vertical thickness 862, at most 1.1 times the top vertical thickness 862, at most 1.15 times the top vertical thickness 862, at most 1.2 times the top vertical thickness 862, or at most 1.25 times the top vertical thickness 862.

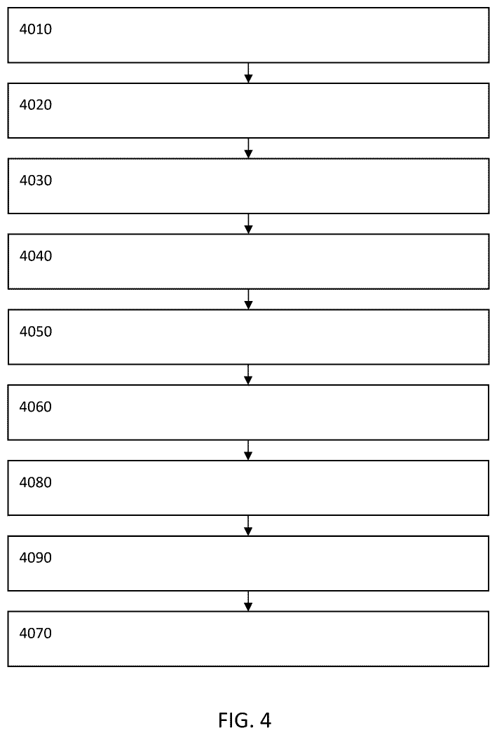

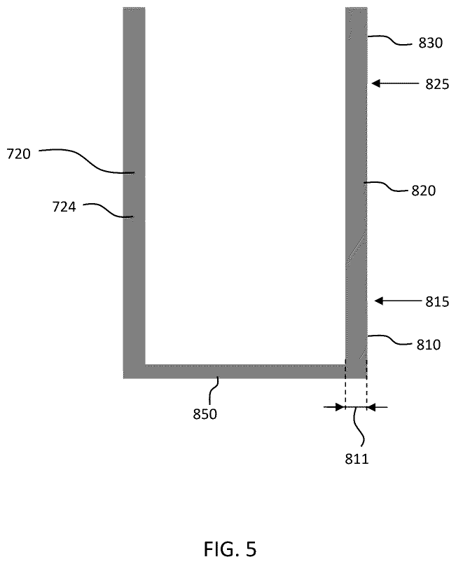

FIG. 4 is a flow chart illustrating a method 1000 for improving thermal performance of a battery enclosure, such as battery enclosure 720 of FIG. 3. FIGS. 5-11 are cross-sectional views, similar to FIG. 3, that illustrate stages of fabrication of the battery enclosure and assembly.

Cross-referencing FIGS. 4 and 5, method 4000 may include, at operation 4010, forming an initial battery enclosure 720. As shown in FIG. 5, in the initial stage the bottom section 810, middle section 820, and top section 830 of the side walls 724 have a substantially constant thickness, which may be equal to thickness 811. In certain embodiments, the initial battery enclosure 720 includes the bottom wall 850, though in other embodiments the bottom wall 850 may be later formed. In certain embodiments, forming the initial battery enclosure 720 includes blanking and drawing a metal into the desired box-like shape.

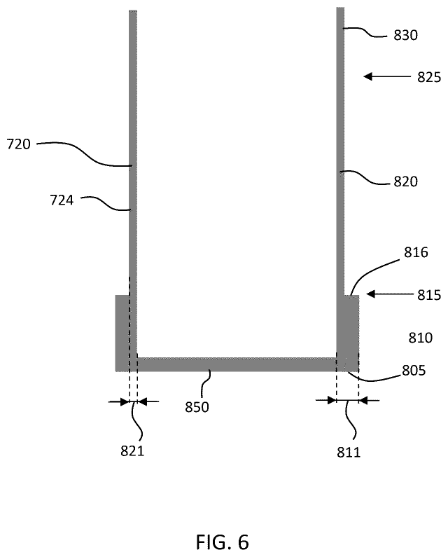

Cross-referencing FIGS. 4 and 6, method 4000 may include, at operation 4020, forming a bottom step. Specifically, bottom shoulder or bottom step surface 816 is formed at the interface 815 of bottom section 810 and middle section 820. As shown, the middle section 820 and top section 830 are reduced in thickness, such as to thickness 821.

In certain embodiments, operation 4020 includes an ironing process to reduce the thickness of the middle sections 820 and top sections 830 of side walls 724. During this process, the bottom section 810 is not fully ironed and remains at the thickness 811 greater than thickness 821.

As shown in FIG. 4, method 4000 may continue at operation 4030 with forming a top step.

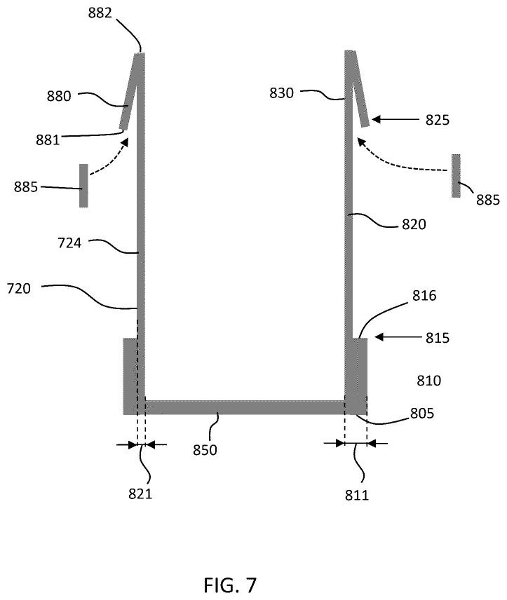

As shown in FIG. 7, the top step may be formed by folding the top section 830. Specifically, the top end 881 and a folded portion 880 of the top section 830 is folded downward to form the top step 826 (shown in FIG. 3). As shown in FIG. 7, the folded portion 880 ends at a fold 882 in the top section 830 that forms the top surface 835 (also shown in FIG. 3).

Operation 4030 may further include locating a weld material 885 between the folded portion 880 and the remaining unfolded top section 830. Then, a welding process is performed to join the folded portion 880 to the remaining unfolded top section 830.

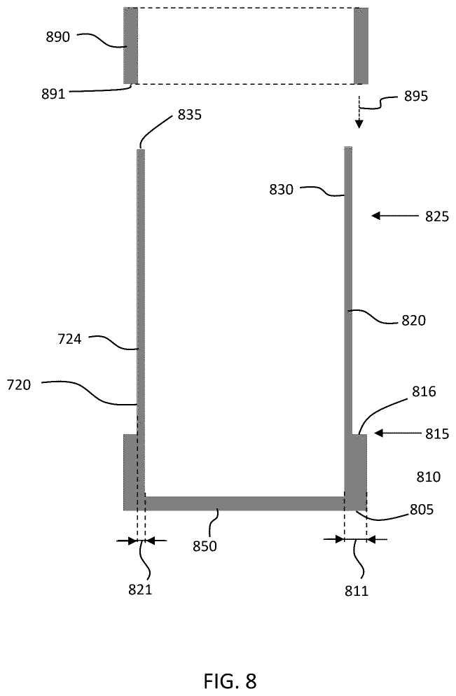

FIG. 8 illustrates an alternative process for forming the top step at operation 4030. In FIG. 8, operation 4030 includes sliding a sleeve 890 over the top end 835 of top section 830, as indicated by arrow 895. A bottom edge 891 of the sleeve 890 extends to and may define the interface 825 between the middle section 820 and the top section 830. Thus, bottom edge 891 may form the top step 826 (shown in FIG. 3). Operation 4030 may include welding the sleeve 890 to the side walls 724. In other embodiments, operation 4030 may include adhering the sleeve 890 to the side walls 724, such as with glue. In certain embodiments, the sleeve 890 is the same material as the enclosure 720. Alternatively, the sleeve 890 may be a different material than the enclosure 720. For example, the sleeve 890 may aluminum, copper, or other suitable material.

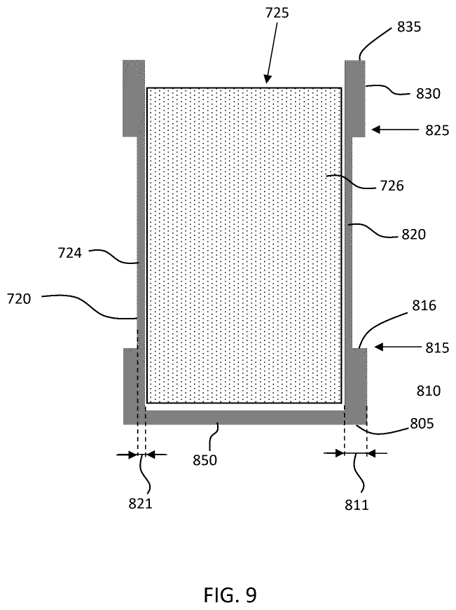

In FIG. 4, method 4000 may continue at operation 4040 with locating internal battery components within the enclosure 720, as shown in FIG. 9.

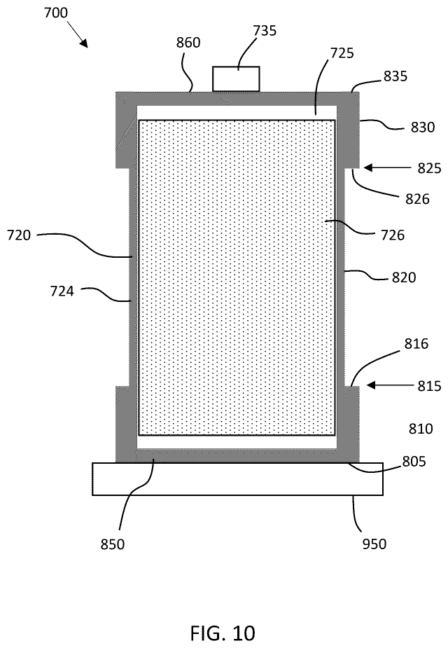

In FIG. 4, method 4000 may continue at operation 4050 with sealing the battery enclosure 720 with the top cap 860, as shown in FIG. 10.

Cross-referencing FIGS. 4 and 10, method 4000 may further include, at operation 4060, contacting the bottom section 810 of the side walls 724 of the enclosure 720 with a heat transfer plate 950, or cold plate 950. For example, operation 4060 may include mounting battery 700 to the cold plate 950.

Still cross-referencing FIGS. 4 and 10, method 4000 may further include, at operation 4070, transferring heat from the battery enclosure 720 (and battery 701) to the heat transfer plate 950 through the bottom surface 805 of the bottom section 810 of the side walls 724. With the increased thickness of the bottom section 810, the heat transfer area between the bottom surface 805 of the bottom section 810 and the heat transfer plate 950 is increased and provided for increased heat transfer, i.e., a faster rate of heat transfer.

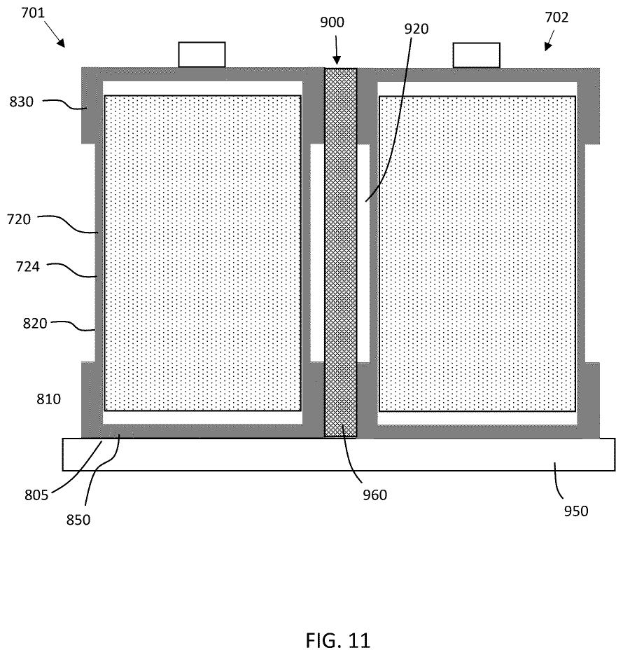

Cross-referencing FIGS. 4 and 11, method 4000 may further include, at operation 4080, placing a barrier 960 in a gap 900 adjacent to the battery 701. In certain embodiments, the barrier 960 is a thermal barrier providing for heat insulation between batteries 701 and 702. For example, the barrier 960 may be formed from an insulative thermoset material.

Cross-referencing FIGS. 4 and 11, method 4000 may further include, at operation 4090, placing a next battery 702 adjacent to a battery 701. Each battery 701 and 702 is formed according to the method for forming battery 700. Operation 4080 may include mounting battery 702 to the cold plate 950 at a located next to battery 701. After locating battery 702 next to battery 701, gap 900 is defined therebetween.

In the embodiment shown, the barrier 960 does not completely fill the gap 900. Rather, voids 920 remain between the middle sections 820 of the side walls 724 of each battery 701 and 702. The presence of the voids 920 allows for each battery 701 and 702 to expand at the respective middle section 820 without constraint to reduce cell swelling force within the batteries at the end of life. Alternatively, a soft foam material may be used to fill the voids 920.

After locating all batteries as desired, method may continue with transferring heat from the respective bottom sections 810 to the heat transfer plate 950, such as during charging and discharging of the batteries, at operation 4070.

In certain embodiments, the enclosure 720 is rectangular. In such embodiments, the top section 830 of each of the four side walls 724 may have the same thickness 831 shown in FIG. 3. In such embodiments, the top shoulder or top step surface 826 is annular, i.e., extends around all four side walls 724 of the enclosure 720. Thus, for such embodiments, FIG. 3 provides a same cross-sectional view across first and third opposite side walls 724, and across second and fourth opposite side walls 724.

In other embodiments, the enclosure 720 is rectangular but does not have an annular top step surface 826. Specifically, first and third opposite side walls 724 are formed with top section 830 having thickness 831 and a top step surface 826, but second and fourth opposite side walls 724 do not have top sections 830 with an increased thickness.

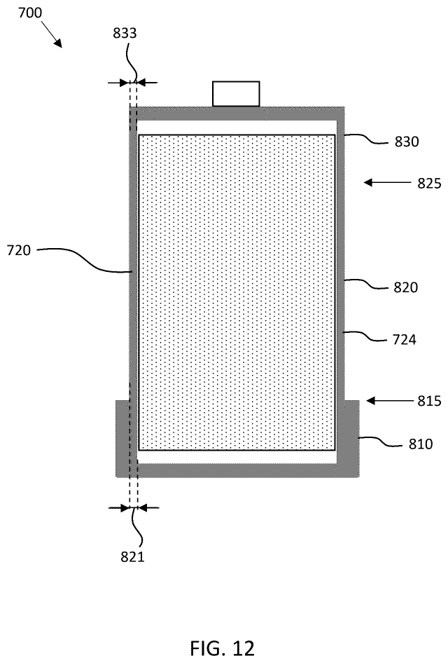

FIG. 12 is a cross-sectional schematic of the battery cell 700 of FIG. 2, taken across second and fourth opposite side walls 724. As shown in FIG. 12, the top section 830 of second and fourth opposite side walls 724 may be formed with a thickness 833 that is equal to or substantially equal to the thickness 821 of the middle section 820 of each side wall 724.

Cross-referencing FIGS. 3 and 12, an enclosure 720 may have first and third opposite side walls 724 formed with top sections 830 having thickness 831 and a top step surface 826, and have second and fourth opposite side walls 724 formed with top sections 830 having thickness 833 and no top step surface 826.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for improving thermal performance of a battery enclosure comprising:
forming the battery enclosure with a bottom wall and a side wall, wherein the side wall includes a bottom section, a middle section, and a top section;
reducing a thickness of the middle section and top section to form a bottom step between the bottom section and the middle section;
forming a top step from the top section; and
locating internal battery components within the battery enclosure;
wherein the top step has a first thickness, the bottom step has a second thickness, and the middle section has a third thickness;
wherein the first thickness is greater than the third thickness; and
wherein the second thickness is greater than the third thickness.

2. The method of claim 1, wherein forming the top step comprises folding the top section to create a fold and inserting a wedge into the fold.

3. The method of claim 2, wherein forming the top step further comprises welding together the fold and the wedge.

4. The method of claim 1, wherein forming the top step comprises placing a sleeve around the top section and welding the sleeve to the top section to form the top step.

5. The method of claim 1, wherein the first thickness is at least 1.5 times greater than the third thickness.

6. The method of claim 1, wherein the second thickness is at least 1.5 times greater than the third thickness.

7. The method of claim 1, wherein the top step surrounds the top section of the battery enclosure, and wherein the bottom step surrounds the bottom section of the battery enclosure.

8. The method of claim 1, wherein improving thermal performance comprises placing a cold plate below the bottom section of the battery enclosure.

9. The method of claim 8, wherein improving thermal performance further comprises transferring heat from the bottom section to the cold plate.

10. The method of claim 1, wherein the battery enclosure is a first battery enclosure, and wherein the method further comprises:
placing a second battery enclosure adjacent to the first battery enclosure, wherein a gap is defined between the first battery enclosure and the second battery enclosure; and
placing a barrier within the gap between the first battery enclosure and the second battery enclosure.

11. The method of claim 10, further comprising configuring the middle section of the first battery enclosure to expand freely into the gap.

12. The method of claim 11, wherein the barrier is comprised of a thermal barrier.

13. A battery enclosure comprising:
a bottom wall;
a side wall including a bottom section, a middle section, and a top section;
a bottom step; and
a top step;
wherein the top step has a first thickness, the bottom step has a second thickness and the middle section has a third thickness; and
wherein the first thickness is greater than the third thickness and the second thickness is greater than the third thickness.

14. The battery enclosure of claim 13, wherein the top step and bottom step are configured to reduce rupture risk of the battery enclosure.

15. The battery enclosure of claim 13, wherein the bottom step is configured to transfer heat to a cold plate.

16. The battery enclosure of claim 13, wherein the bottom step completely surrounds the bottom section of the battery enclosure.

17. The battery enclosure of claim 13, wherein the top step completely surrounds the top section of the battery enclosure.

18. The battery enclosure of claim 13, wherein the first thickness is at least 1.5 times greater than the third thickness.

19. The battery enclosure of claim 13, wherein the second thickness is at least 1.5 times greater than the third thickness.

20. A vehicle comprising:
an electric motor configured to provide motive torque; and
a battery system operatively connected to the electric motor and operable to provide electrical power to the electric motor, wherein the battery system comprises a battery enclosure surrounding an internal space and including a bottom wall and a side wall, wherein:
the side wall includes a bottom section, a middle section, and a top section;
a bottom step is formed at a bottom interface between the bottom section and the middle section;
a top step is formed at a top interface between the top section and the middle section;
the top section is at least 1.5 times thicker than the middle section;
the bottom section is at least 1.5 times thicker than the middle section;
the bottom step is configured to transfer heat;
the bottom step and top step are configured to structurally strengthen the battery enclosure;
the middle section is configured to allow swelling of internal battery components by expanding to increase a volume of the internal space.
